(19) United States
(12) Patent Application Publication
(10) Pub. No.: US 2010/0017639 A1
(43) Pub. Date: Jan. 21, 2010

(54) POWER MANAGEMENT APPARATUS AND METHODS

(75) Inventors: Yen-Chao Chen, Taichung (TW); Jung-Ching Wang, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIA OPTICAL CO., INC., Taichung (TW)

(21) Appl. No.: 12/360,124

(22) Filed: Jan. 27, 2009

(30) Foreign Application Priority Data
Jul. 18, 2008 (TW) 97127313

(51) Int. Cl. G06F 1/28

(52) U.S. Cl. 713/340

(57) ABSTRACT

A power management apparatus including power supply circuit and control unit is disclosed. The power supply circuit receives input voltage having voltage value, and converts voltage value into a first converted signal having a first voltage value and a second converted signal having a second voltage value through first and second converters, respectively. The first and second converters are reset according to first and second reset signals, respectively. The control unit receives the first and second converted signals, and compares the first and second voltage values with first and second reference ranges, respectively. The control unit further issues first reset signal when first voltage value is not within first reference range and second voltage value is within second reference range, and issues second reset signal when first voltage value is within first reference range and second voltage value is not within second reference range.

This Application claims priority of Taiwan Patent Application No. 097127313, filed on Jul., 18, 2008, the entirety of which is incorporated by reference herein.

### BACKGROUND OF THE INVENTION

1. Field of the Invention

The invention relates generally to a power management apparatus and method, and more particularly, to a power management apparatus and method that prevents voltage failure.

2. Description of the Related Art

Electronic products are widely used for various means. For example, an outdoor digital camera is often used to record the life of wild animals. Since the outdoor digital camera is usually set up in an out-of-the-way place where the wild animals habitat, maintenance is troublesome, especially for power failure.

### BRIEF SUMMARY OF THE INVENTION

In light of the previously described problems, the objective of the invention is to provide a power management apparatus and method that prevents power failure. With the apparatus and method, the related mechanism will be automatically activated when unstable power status is determined.

The invention discloses a power management apparatus comprising a power supply circuit and a control unit. The power supply circuit receives an input voltage having a voltage value, and converts the voltage value into a first converted signal having a first voltage value and a second converted signal having a second voltage value respectively through a first converter and a second converter. The first converter is reset according to a first reset signal, and the second converter is reset according to a second reset signal. The control unit receives the first converted signal and the second converted signal, and compares the first voltage value with a first reference range and the second voltage value with a second reference range. The control unit further issues the first reset signal when the first voltage value is not within the first reference range and the second voltage value is within the second reference range, and issues the second reset signal when the first voltage value is within the first reference range and the second voltage value is not within the second reference range.

The invention further discloses a power management method, comprising, receiving an input voltage having a voltage value, converting the voltage value into a first voltage value and a second voltage value respectively through a first converter and a second converter, and comparing the first voltage value with a first reference range and the second voltage value with a second reference range. The method further comprises resetting the first converter when the first voltage value is not within the first reference range and the second voltage value is within the second reference range, and resetting the second converter when the first voltage value is within the first reference range and the second voltage value is not within the second reference range.

The invention discloses a power management apparatus comprising a power supply circuit and a control unit. The power supply circuit receives an input voltage having a first voltage value, and converts the first voltage value into at least a converted signal having a second voltage value through at least a converter, wherein each of at least the converter is reset according to a reset signal corresponding thereto. The control unit receives the converted signal and compares each of at least the second voltage value with a reference range corresponding thereto. The control unit further issues the reset signal when one of at least the second voltage value is not within the reference range corresponding thereto.

### BRIEF DESCRIPTION OF THE DRAWINGS

The invention can be more fully understood by reading the subsequent detailed description and examples with references made to the accompanying drawings, wherein:

FIG. 1 depicts a block diagram of an embodiment of a power management apparatus according to the invention; and

FIG. 2 depicts an operation flowchart of an embodiment of a power management apparatus according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

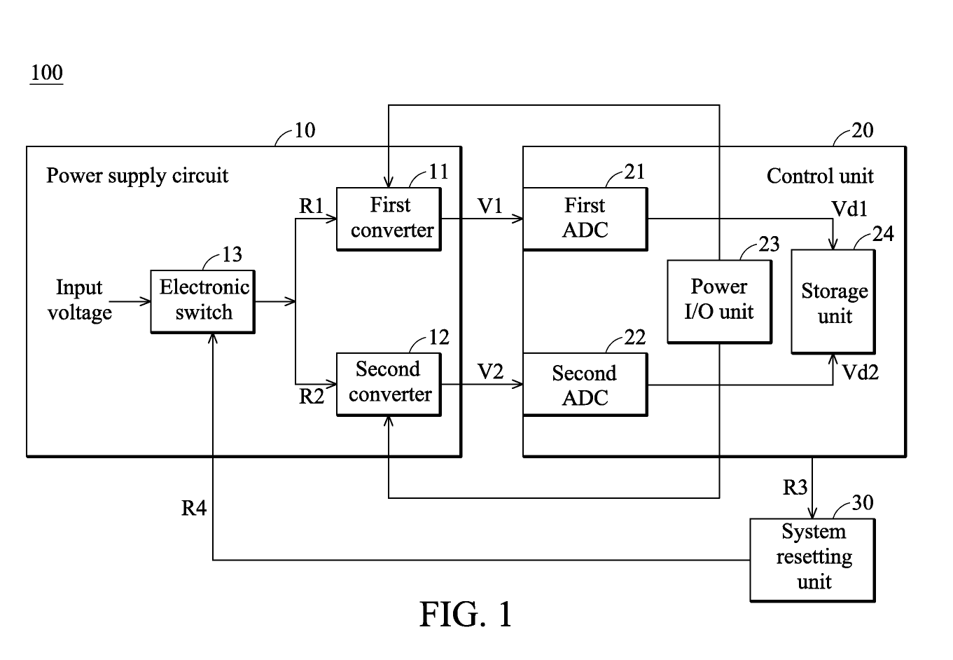

FIG. 1 depicts a block diagram of an embodiment of a power management apparatus 100 according to the invention. The power management apparatus 100 comprises a power supply circuit 10, a control unit 20 and a system resetting unit 30. The power supply circuit 10 comprises a first converter 11, a second converter 12 and an electronic switch 13. The control unit 20 comprises a first analog to digital converter (ADC) 21, a second ADC 22, a power I/O unit 23 and a storage unit 24 storing a program.

The power supply circuit 10 first receives an input voltage Vin having a voltage value (6 Volt as an example hereinafter) through the electronic switch 13, and the input voltage Vin is then converted into a first voltage value V₁ and a second voltage value V₂ respectively through the first converter 11 and second converter 12. In the embodiment, the first converter and second converter both are DC (Direct Current) to DC converter. The first ADC 21 receives the first voltage value V₁ and converts the first voltage value V₁ into a first digital value V_{d1}, and the second ADC 22 receives the second voltage value V₂ and converts the second voltage value V₂ into a second digital value V_{d2}. Additionally, the program stored in the storage unit 24 first sets a first reference range corresponding to the first voltage value V₁, and a second reference range corresponding to the second voltage value V₂.

Following, determination of the first and second reference ranges will be described. The first reference range is determined based on the expected output voltage value of the first converter 11. More specifically, a tolerance range from the expected output voltage value of the first converter 11 is determined. For instance, if the first converter 11 is expected to output the voltage of 1.8V, then the first reference range is taken between 1.98V and 1.62V, as the tolerance range being 10% for 1.8V. Similarly, if the second converter 12 is expected to output the voltage of 2.5V, then the second reference range is determined to be between 2.75V and 2.25V. The first and second reference ranges are indicative of the voltage tolerance for normal operation of the power management apparatus 100, which can be adjusted without affecting the normal operation of the power management apparatus 100. Usually, the tolerance for DC voltage is 10%. Therefore, any voltage variation beyond 10% could cause potential voltage failure.

The first ADC 21 and second ADC 22 have an N-bit resolution and a reference voltage. The reference voltage is indicative of the maximum voltage value that can be expressed by the N-bit resolution. For example, assume that the first ADC 21 has a 12-bit resolution and a reference voltage of 3.3V, that means there are 2¹² voltage expression values (ranging from 0 to 4095) for the first ADC 21. Following, the 3.3V reference voltage will be represented by the full scale 4095.

As described above, the first ADC 21 receives the first voltage value V₁ and converts the first voltage value V₁ into a first digital value V_{d1}, and the second ADC 22 receives the second voltage value V₂ and converts the second voltage value V₂ into a second digital value V_{d2}. Next, the first digital value V_{d1} and the second digital value V_{d2} are expressed with a specific number system through the following formula:

$$( \frac{A}{B} ) * C ,$$

wherein, A is the voltage value V₁ or V₂, B is the reference voltage, and C is the voltage maximum expression value of ADC 21 or 22. For example, if the received voltage value V₁ or V₂ is 1.8V, then the converted digital value would be (1.8/3.3)*4096=2234, which is further expressed in a hexadecimal system for computer retrieval.

After the first voltage value V₁ and the second voltage value V₂ are converted, the program stored in the storage unit 24 will compare the first digital value V_{d1} with the first reference range, and the second digital value V_{d2} with the second reference range. In a normal case when the voltage system is stable, the real output voltage value of the first converter 11 is close to its expected output voltage value. In other words, if the first converter 11 is expected to output the voltage value of 1.8V, then its real output might be close to 1.8V, say 1.81V or 1.79V, for example. In this case, the first ADC 21 receives the 1.81V and then converts it into the first digital value V_{d1} which is further expressed in hexadecimal system (8C7). Finally, the program compares the value 8C7 with the first reference range 1.62V to 1.98V (7DB to 99A).

The above describes a normal case when the real output voltage value appears to be close to the expected output voltage value for converter 11/21. However, the power system may become unstable. In this case, the difference between the real output of converter 11/12 and the expected output may be great. For example, the first converter 11 might end up outputting 2.3V as a real output which is much more than it should output (1.8V). With the real output at 2.3V, the converted first digital value V_{d1} would be B27. Then, the program would compare B27 with the first reference range 7DB to 99A, and determine that B27 is not within the first reference range 7DB to 99A. As a result, a variable X₁ corresponding to the first digital value V_{d1} would be set as a setting value by the program, wherein the variable X1 set as the setting value would serve as an indication of an abnormal power status. Furthermore, the second voltage value V₂ would also be executed with the same procedures as described above. If the second voltage value V₂ is not within the second reference range, a corresponding variable X₂ would also be set as the setting value for indication of an abnormal power status.

Finally, the program would determine that the variables X₁ and X₂ are both set as the setting value, meaning that they are both in the abnormal power status condition. In a first case, the variable X₁ is solely set as the setting value (i.e. only the first voltage value V₁ is not within the first reference range), and then the power I/O unit 23 would issue a first reset signal R₁ to the first converter 11 to initialize the first converter 11. This way, the first converter 11 will be initialized, preventing an unstable first voltage value V₁ from being output. After initialization, the first voltage value V₁ is re-output. In a second case, the variable X₂ is solely set as the setting value (i.e. only the second voltage value V₂ is not within the second reference range), and then the power I/O unit 23 issues a second reset signal R₂ to the second converter 12 to initialize the second converter 12. This way, the second converter 12 will be initialized, preventing an unstable second voltage value V₂ from being output. After the initialization, the second voltage value V₂ is re-output. In a third case, both variables X₁ and X₂ are set as the setting value (i.e. both first and second voltage values V₁ and V₂ are not within their corresponding reference ranges), and then the control unit 20 issues an input voltage resetting command R₃ to the system resetting unit 30. Upon reception of the input voltage resetting command R₃, the system resetting unit 30 issues an input voltage resetting signal R₄ to the electronic switch 13. In response, the electronic switch 13 stops providing the input voltage Vin to the first and second converters 11 and 12 for a predetermined time period, and then re-provides the input voltage Vin to the first and second converters 11 and 12. During the time period when the input voltage Vin is stopped from being provided, the unstable first and second voltage values V₁ and V₂ will be reset as not providing a voltage source. After the predetermined time period when the input voltage Vin starts to provide a voltage source, the first and second voltage values V₁ and V₂ can be re-output.

Note that the control unit 20 can be implemented with a microcontroller unit (MCU), a digital signal processor (DSP), a central processor unit (CPU), a field-programmable gate array (FPGA) or a complex programmable logic device (CPLD). If the control unit 20 is implemented with an MCU, a plurality of ADCs are provided so that the power management of a plurality of voltage values can be accomplished. In addition, the reference voltage of the ADCs may be programmable. Also note that the voltage values V₁ and V₂ must be converted into a smaller voltage value if they exceed the ADCs reference voltage, as the voltage values V₁ and V₂ larger than the reference voltage would not be able to be analyzed by the ADCs. As a result, the tolerance range would be based on a newly-converted smaller voltage value.

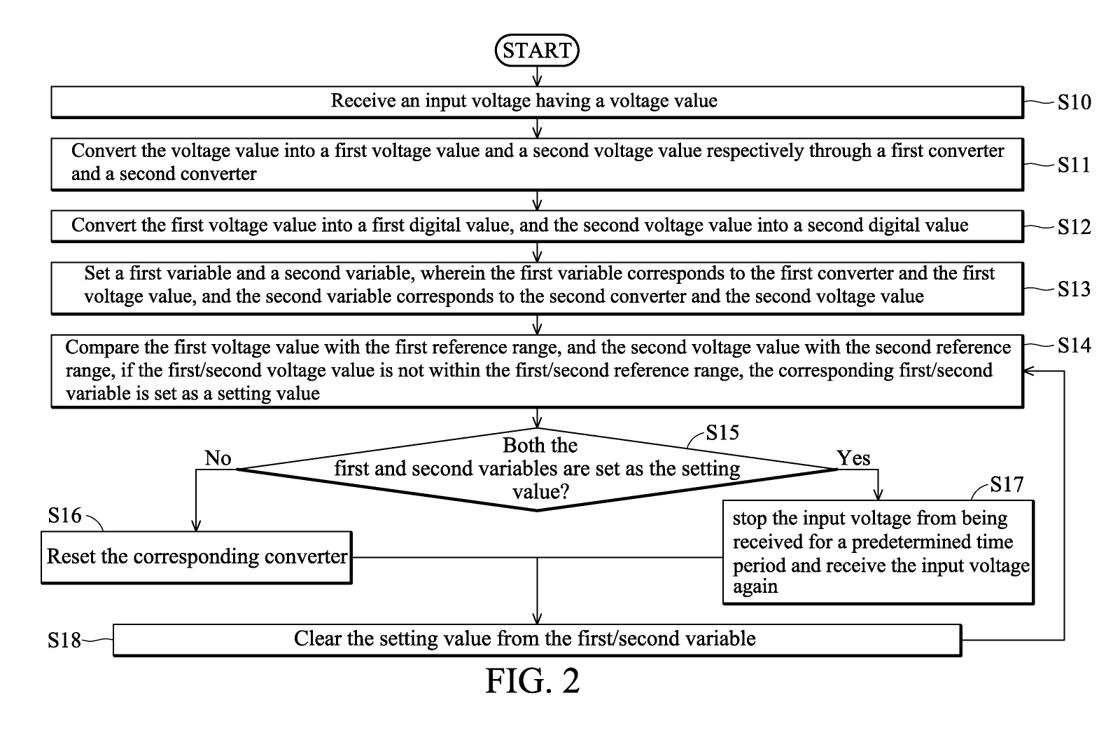

FIG. 2 depicts an operation flowchart of an embodiment of a power management apparatus 100 according to the invention. First of all, an input voltage having a voltage value is received (step S10). In the next step, the voltage value is converted into a first converted signal having a first voltage value and a second converted signal having a second voltage value respectively through a first converter and a second converter (step S11). In the next step, the first voltage value is converted into a first digital value, and the second voltage value is converted into a second digital value (step S12). In the next step, a first variable and a second variable are set (step S13). The first variable corresponds to the first converter and the first voltage value, and the second variable corresponds to the second converter and the second voltage value. In the next step, the first voltage value is compared with the first reference range, and the second voltage value is compared with the second reference range (step S14). If the first/second voltage value is not within the first/second reference range, the corresponding first/second variable is set as a setting value (step S14). In the next step, it is determined whether both the first and second variables are set as the setting value (step S15). In the next step, if the first or second variable is set as the setting value, then the corresponding converter is reset (step S16). In the next step, the input voltage is stopped from being received for a predetermined time period, and then resumed (step S17). In the final step, the first or second variable is set as the setting value is cleared, and the monitoring of voltages is continued (step S18).

In the above embodiment, the power I/O unit 23 issues the first reset signal R₁ to the first converter 11 for initialization in the case where the variable X₁ is solely set as the setting value (i.e. the first voltage value V₁ is not within the first reference range, but the second voltage value V₂ is within the second reference range), and the power I/O unit 23 issues the second reset signal R₂ to the second converter 12 for initialization in the case where the variable X₂ is solely set as the setting value (i.e. the first voltage value V₁ is within the first reference range, but the second voltage value V₂ is not within the second reference range). However, in another embodiment, the control unit 20 may issue the input voltage resetting command R₃ to the system resetting unit 30 either in the situation where only the first voltage value V₁ is not within the first reference range or only the second voltage value V₂ is not within the second reference range. In response to receiving the input voltage resetting command R₃, the system resetting unit 30 issues the input voltage resetting signal R₄ to the electronic switch 13 so that the input voltage Vin is stopped from being provided to the first and second converters 11 and 12 for a predetermined time period, and then re-provided to the first and second converters 11 and 12. In other words, the system resetting unit 30 may reset the electronic switch 13 directly once the voltage abnormality occurs on either the first voltage value V₁ or second voltage value V₂.

In addition, although the above embodiment describes that the input voltage Vin is converted into the first voltage value V₁ and the second voltage value V₂ respectively through the two converters 11 and 12, the conversion may also be accomplished with a single converter having a plurality of voltage channels. In this case, the converter or the electronic switch 13 may be directly reset once the abnormal voltage occurs on either the first voltage value V₁ or the second voltage value V₂. In addition, in another embodiment where a single converter outputs both the first and second voltage values V₁ and V₂, if the abnormal voltage occurs on one of the first and second voltage values V₁ and V₂, the abnormal voltage value may be reset, (ex. the voltage value V₁ may be reset when the abnormal voltage occurs only on the first voltage value V₁ but not on the second voltage value V₂), or the electronic switch 13 may be reset.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power management apparatus, comprising:
a power supply circuit receiving an input voltage having a voltage value, and converting the voltage value into a first converted signal having a first voltage value and a second converted signal having a second voltage value respectively through a first converter and a second converter, wherein the first converter is reset according to a first reset signal, and the second converter is reset according to a second reset signal; and
a control unit receiving the first converted signal and the second converted signal, and comparing the first voltage value of the first converted signal with a first reference range and the second voltage value of the second converted signal with a second reference range, wherein the control unit further issues the first reset signal when the first voltage value is not within the first reference range and the second voltage value is within the second reference range, and issues the second reset signal when the first voltage value is within the first reference range and the second voltage value is not within the second reference range.

2. The power management apparatus as claimed in claim 1, wherein the control unit comprises a first analog to digital converter and a second analog to digital converter.

3. The power management apparatus as claimed in claim 1, wherein the power supply circuit comprises an electronic switch directing the input voltage to the first converter and the second converter, and re-providing the input voltage to the first converter and the second converter after the input voltage to the first converter and the second converter is stopped for a predetermined time period according to an input voltage resetting signal.

4. The power management apparatus as claimed in claim 3, further comprising a system resetting unit issuing the input voltage resetting signal according to an input voltage resetting command, wherein the control unit issues the input voltage resetting command when the first voltage value is not within the first reference range and the second voltage value is not within the second reference range.

5. The power management apparatus as claimed in claim 1, wherein the control unit is an MCU, DSP, CPU, FPGA or CPLD.

6. The power management apparatus as claimed in claim 3, wherein the control unit comprises a storage unit for storing a program, the program has a first variable and a second variable, and the program sets the first variable as a setting value when the first voltage value is not within the first reference range and sets the second variable as the setting value when the second voltage value is not within the second reference range.

7. The power management apparatus as claimed in claim 6, wherein the program further determines whether the first variable and the second variable are both set as the setting value, and the input voltage resetting signal is issued when the first variable and the second variable are both set as the setting value.

8. A power management method, comprising:
receiving an input voltage having a voltage value;
converting the voltage value into a first voltage value and a second voltage value respectively through a first converter and a second converter;
comparing the first voltage value with a first reference range and the second voltage value with a second reference range; and
resetting the first converter when the first voltage value is not within the first reference range and the second voltage value is within the second reference range.

9. The power management method as claimed in claim 8, further comprising:
resetting the second converter when the first voltage value is within the first reference range and the second voltage value is not within the second reference range.

10. The power management method as claimed in claim 9, further comprising performing the following procedures when the first voltage value is not within the first reference range and the second voltage value is not within the second reference range:
stopping the input voltage from being received for a predetermined time period; and
receiving the input voltage again.

11. The power management method as claimed in claim 9, further comprising:
setting a first variable and a second variable;
setting the first variable as a setting value when the first voltage value is not within the first reference range; and
setting the second variable as the setting value when the second voltage value is not within the second reference range.

12. The power management method as claimed in claim 11, further comprising:
determining whether the first variable and the second variable are both set as the setting value;
stopping the input voltage from being received for a predetermined time period; and
starting to receive the input voltage again when the first variable and the second variable are both set as the setting value.

13. A power management apparatus, comprising
a power supply circuit receiving an input voltage having a first voltage value, and converting the first voltage value into at least a converted signal having a second voltage value through at least a converter, wherein each of at least the converter is reset according to a reset signal corresponding thereto; and
a control unit receiving the converted signal and comparing each of at least the second voltage value with a reference range corresponding thereto, wherein the control unit further issues the reset signal when one of at least the second voltage value is not within the reference range corresponding thereto.

14. The power management apparatus as claimed in claim 13, wherein the control unit comprises at least an analog to digital converter corresponding to the second voltage value.

15. The power management apparatus as claimed in claim 13, wherein the power supply circuit comprises an electronic switch directing the input voltage to at least the converter, and re-providing the input voltage to at least the converter after the input voltage to at least the converter is stopped for a predetermined time period according to an input voltage resetting signal.

16. The power management apparatus as claimed in claim 15, further comprising a system resetting unit issuing the input voltage resetting signal according to an input voltage resetting command, wherein the control unit issues the input voltage resetting command when each of at least the second voltage value is not within the reference range.

17. The power management apparatus as claimed in claim 13, wherein the control unit is an MCU, DSP, CPU, FPGA or CPLD.

18. The power management apparatus as claimed in claim 15, further comprising a system resetting unit, wherein the control unit comprises a storage unit storing a program, the program has at least a variable corresponding to at least the second voltage value, and the program sets one of at least the first variable as a setting value when one of at least the second voltage value corresponding thereto is not within the reference range.

19. The power management apparatus as claimed in claim 18, wherein the program further determines whether each of at least the first variable is set as the setting value, and the input voltage resetting signal is issued when each of at least the first variable is set as the setting value.
